(19) United States
(12) Patent Application Publication
(10) Pub. No.: US 2021/0187557 A1
(43) Pub. Date: Jun. 24, 2021

(54) Automation System and Method for Sorting Returnable Racks

(71) Applicant: Leandro VETTORAZZI, Porto Alegre (BR)

(72) Inventor: Leandro VETTORAZZI, Porto Alegre (BR)

(21) Appl. No.: 16/860,055

(22) PCT Filed: Oct. 27, 2017
(86) PCT No.: PCT/BR2017/050325

§ 371 Date: Apr. 27, 2020

(51) Int. Cl. B07C 5/342; B07C 5/36

(52) U.S. Cl. CPC B07C 5/3422; B07C 2501/0063; B07C 5/362

(57) ABSTRACT

An automation system and method are described for sorting returnable clothing hangers in a distribution center, allowing the separation of the items according to categories that are previously predefined in the control unit, organizing the items to return to the production cycle and/or for disposal. The system has an initial area of entry for the flow of coat hangers and physical separation of the items (Aing) followed by an area for recording an image of each coat hanger (Areg), followed by a screening area of the hangers (Atr) and an area in packaging (Aac) the hangers (200) that are being moved sequentially by means of a conveyor belt that ensuring a linear and continuous flow of the hangers through the system.

### CROSS REFERENCE TO RELATED APPLICATION

This application is a continuation of applicant's co-pending application Ser. No. PCT/BR2017/050325 filed Aug. 27, 2019 and application Ser. No. WO2019079867 filed Oct. 27, 2017 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in an automation system and method for screening returnable coat hangers. More specifically, it comprises a system and method that allows the management of returnable hangers in a distribution center, allowing the separation of items according to categories that are defined in the control plant, organizing the items for return to the production cycle and/or disposal of the items.

### Description of Related Art Including Information Disclosed Under 37 CFR 1.97 and 1.98

Reverse logistics is an area of business logistics that is concerned with the multiplicity of logistical aspects of the returning of different types of industrial goods, the materials that constituting them and industrial waste, adding value of different types as described in: economic, ecological, legal, logistical, corporate image, inter alia (LEITE, Paulo R. (2002)—Logistica reversa: nova area da logistica empresarial. Tecnologistica, Year VII, n. 78, pp. 102-109).

Reverse flow can happen through the return of after-sales goods and products with little or no use that can return to the business cycle and of post-consumer goods that are used, durable or disposables, which can be reused, recycled or destined for final disposal as described in: (LEITE, Paulo R. (2000)—Canais de distribuição reversos 8a parte. Tecnologistica, Year VI, n. 61, pp. 6067).

In the case of large department stores, the reverse flow of hangers represents is an important part of the operation. These materials are usually returned to suppliers, and must be classified in order to receive the proper treatment—disposal or reuse as described in: (Rodrigues, Gisela Gonzaga. A logistica reversa nos centros de distribuição de lojas de departamento. PUC-Rio. XXIII National Meeting of Production Engineers—Ouro Preto, MG, Brazil, 21-24 Oct. 2003).

The handling and screening of these items is done manually where the items are separated by model and packed in cardboard boxes. In the distribution centers, or in the logistics operator, the hangers are transported by conveyors and separated through human operations, where the hangers in conditions of use are return to stores and those that are outside the quality standards that are required by customers are recycled.

The operations for screening and evaluating the model and the coat hanger conditions are purely visual and manual. Failures of the coat hangers can cause serious problems when clothes are placed on the recycled hangers. For example, an important and fragile hanger hook that is oxidized can cause damage to the clothes that are placed on the hanger so a good article of clothing can be damaged thereby making the clothing inappropriate for sale. Inspecting the hanger is critical, as well as checking for cracks, breaks or dirt in the coat hanger body, which make the item unsuitable for reuse.

Another problem concerns the coat hangers packaging in the exact quantity to be sent to the distribution center, which must be equivalent to the quantity of clothes that the clothing supplier releases. This ensures that all the clothes will be put in coat hangers for display at the point of sale.

Thus, the coat hanger is a fundamental part of the clothing logistics chain, as it allows the clothes display at the point of sale, in suitable conditions of display. Furthermore, the volume of coat hangers demanded by large department stores implies constant reverse logistics operations that must be monitored in order to prevent the lack of a coat hanger for the display of clothes or coat hangers that are unsuitable for a given clothing or coat hangers that cause damage to the clothes.

A number of patents and or publications have been made to address these issues. Exemplary examples of patents and or publication that try to address this/these problem(s) are identified and discussed below.

CN103043414 document describes an automatic system for separating, suspending and coat hangers transporting arranged on a transport chain and a clothes feed rod, having a code reader that ensures that only one clothes is hung on each link of the connecting rod.

JPH03184655 document describes a coat hanger arrangement and movement device, separation device to hold the coat hanger one by one and rotation device to lower the coat hanger by turning the separating device and releasing the coat hanger with the separating devices to fit it into clothes.

U.S. Pat. No. 5,971,131 document describes a method for grouping items transported to create different units, depending on the item's sizes, determining the maximum unit's length, feeding the units in a space within a transfer interval and then transferring the unit within a discharge range.

JPH069026 document describes a handling system, automating the suspension and removal of a coat hanger on a hanging cart, with a bar to hang the hanger on the hanging cart so that a hanger can pass.

JPH06211327 describes a method that aims to rationalize a system on a sewing product production line and rationalize a handling system in a collection and delivery center for a finished sewing product, automating the hooking and removal of a coat hanger, where the coat hangers are hung on a suspension bar of a cart equipped with a collection ramp that in a single stroke transfers the coat hanger to the outside of the suspension cart.

None of these references describe or suggest an automatic system and method for screening coat hangers, in order to select items according to parameters defined in an electronic control unit, ensuring that non-compliant items, signaled by control unit from the images obtained, are removed from the processing area, ensuring that only items equipped with visual conformity are sent for packaging, in order to return the coat hangers in structural and visual conditions to the production cycle, arranged in models and in the precise quantities.

### BRIEF SUMMARY OF THE INVENTION

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows the schematic representation of the automation system for screening returnable hangers.

FIG. 2 shows a first part of the automated method of screening returnable hangers.

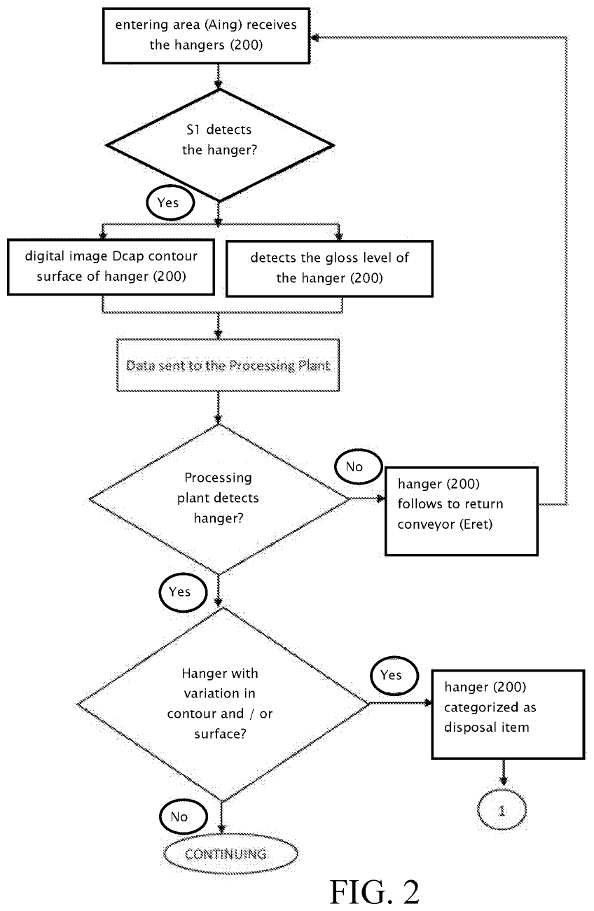

FIG. 3 shows a second part of the automated method of screening returnable hangers.

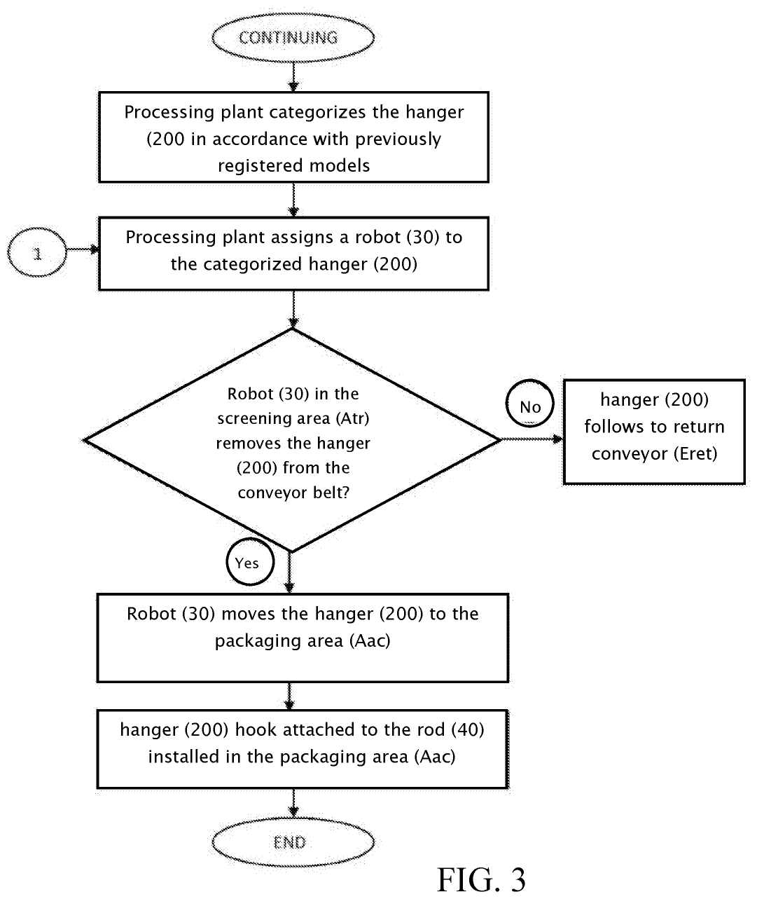

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| Aac packaging area | Aing entering area |
| Areg clothing hanger image | Aret return conveyor |
| Atr screening area | Dcap digital image |
| Eret return conveyor | S1 sensor element |
| S2 sensor | S3 sensor |
| 10 first conveyer belt | 20 second conveyer belt |
| 30 robot | 40 rod |
| 50 container | 101 stops |
| 200 hanger(s). | |

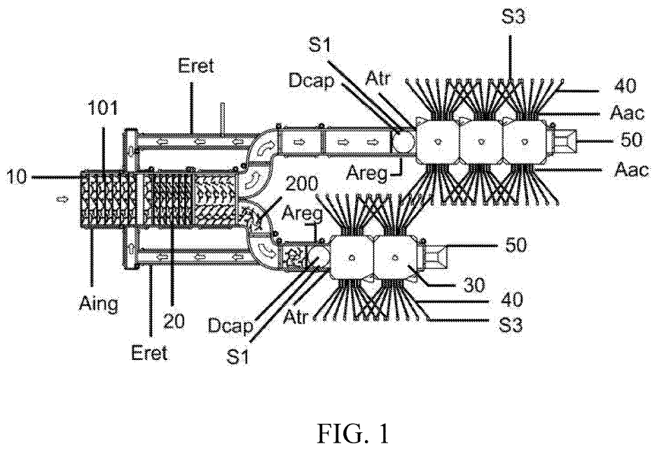

FIG. 1 shows the schematic representation of the automation system for screening returnable coat hangers.

The automation system for screening returnable coat hangers, purpose of this invention, comprises an initial area for entering the flow of coat hangers and physically separating the items (Aing) followed by an area for registering the clothing hanger image (Areg), followed by a coat hanger screening area (Atr) and a packaging area (Aac), the coat hangers (200) being moved sequentially by means of conveyor belts that ensuring a linear and continuous flow.

As the garment hanger enter into the system the hanger are separated (Aing), on a first conveyor belt (10). The first conveyer belt (10) is upward slopes, and the first conveyor belt (10) moves the flow of clothing hangers (200).

On the surface of the first conveyor belt (10), stops (101) are provided as a means of retaining the coat hangers (200) to promote the physical separation of the hangers (200) and to prevent overlapping. The separation ensures that each hanger (200) is maintained positioned on the surface of the first conveyor belt (10) without any overlap.

Sequentially to the first conveyor belt (10), a second conveyor belt (20) is arranged at a higher speed than the first conveyor belt (10), so that the difference in speed of the second conveyor belt (20) to the speed of to the first conveyor belt (10) promotes a physical distance between the clothing hangers (200).

A clothing hanger image (Areg) registration area is located sequentially to the second conveyor belt (20) and there is at least one sensor element (S1) that detects the presence of a clothing hanger (200) on the surface of the conveyor belt. The at least one sensor element (S1) trigger a digital device image capture (Dcap).

The digital device that captures the digital image (Dcap) is preferably installed on the conveyor belt to record the clothing hanger (200). The digital image (Dcap) is processed to detect the gloss surface level on the surface of the clothes hanger (200) as the clothing hanger (200) is transported by the conveyor belt. The digital image (Dcap) is processed for the contour, surface and gloss on the clothing hanger and is sent to the processing plant (not shown).

The processing plant (not shown) analyzes the digital image (Dcap) that is acquired by the digital device and extracts attributes relative to the contour and gloss intensity and provides a numerical data to classify the coat hanger in accordance with the models previously registered in the processing plant. The numerical data allows the processing plant to categorizing the coat hanger, as well as detecting variations in the hanger (200) that may indicate possible cracks, breaks or dirt that may classify the hanger (200) for disposal.

The attributes registered in the processing plant generate classification sub-items that categorize the hangers (200). As an example, A1 (hanger with a defective surface), A2 (hanger with a defective metal hook), A3 (returnable hanger model “X”), A4 (returnable hanger for “Y” model) and An (returnable hanger for “n” model).

If the hanger (200) contour is equivalent to the pattern stored in the processing unit's memory, the hanger (200) is categorized, as previously exemplified.

If the hanger's (200) contour on the surface differs from the pattern stored in the processing unit's memory, the hanger is classified as a disposal item.

If the gloss level detected by the sensor (S2) is less than the value registered in the processing plant database, the hanger (200) is classified as a disposal item.

The gloss level on the surface of the hanger (200) is analyzed and makes it possible to detect damage to the metallic surface of the hook on the hanger (200), which is the most relevant component and which requires greater attention in the screening process due to the possibility of oxidation, which prevents reuse of the hanger (200). If the gloss level on the hook is less than the value defined in the processing plant, it indicates of the presence of oxidation points on the hook.

Optionally, image pre-processing steps are provided to improve the image quality and/or segmentation step, where the image is separated into parts of interest.

The hanger (200) is properly categorized by the processing plant and goes through the conveyor belt to the hanger screening area (Atr) where at least one parallel robot (30) is installed that removes the assigned hanger (200) from the surface of the conveyor belt and moves this hanger (200) to a packing area (Aac).

In the case of two or more parallel robots (30), each hanger (200) is categorized by the processing plant is assigned to an ordered robot (30).

Optionally, the same robot (30) can be designated by the processing plant to the screening of several hanger (200) categories, so that each category is assigned to a rod (40) in the packaging (Aac) area.

As those versed with the subject knowledge, a parallel robot (30) comprises a device actuated by a processing plant with mechanical elements that include linear bars that are triggered by motors that generate angular movements, so that the tool arranges at the linear bar ends of the hanger (200) for the displacement between the conveyor belt surface of the screening area (Atr) and the hanger storage area (Aac).

In the packaging area (Aac), there are multiple rods (40). The hangers are placed on the rods (40) by a robot (30). To determine a precise counting of hangers a sensor (S3) determines when a sufficient quantity of hangers (200) are on the rod (40). When the sensor (S3) identifies the packaged hangers (200) in the quantity defined in the processing plant, the processing plant indexes the full rod (40) and presents an empty rod (40) for the robot (30) to fill. The indexing of the rod (40) can be made with automatically with movers, or triggered visual and/or with audible alerts in a manual operation.

For the purpose of this invention, the robot (30) removes the coat hanger from the conveyor belt from the screening area (Atr) and performs an angular movement in order to position the hanger (200) hook on the rod (40), so the hook on the hanger (200) can be positioned with the opening of the hook being oriented in any direction.

The hanger(s) (200) that are not identified by the processing plant are returned to the entering area (Aing). Hanger (200) that are not categorized enter a return conveyor (Eret) and pass through the image registration area to get another clothing hanger image (Areg) for reprocessing.

A reason for not identifying the hanger (200) by the processing plant can be non-detection of the contour of the hanger (200) caused by overlapping hangers (200). In this case, the image recorded by the digital image (Dcap) of the capture device does not find an equivalent in the processing plant's database, so that the coat hanger (200) is sent to the return conveyor (Eret).

Another reason for not identifying the hanger (200) by the processing plant can be an error in image detection that is recorded by the digital image (Dcap) of the capture device, so the hanger (200) is also returned to the return conveyor (Eret).

In case where the robot (30) does not match the hanger (200) to a known categorized image the hanger (200) can be returned to the entering area (Aing) for reprocessing or the unknown hanger (200) can be released in a container (50) for disposal of the hanger (200) at the screening area (Atr) exit, as shown in FIG. 1.

In case the number of coat hangers (200) assigned to a robot (30) is greater than the operating capacity of the robot (30), the processing plant can assign a second robot (30) to index the rod (40) and relieve the first robot (30) or release the hangers (200) to the return conveyor (Eret).

Thus, specific embodiments of an automation system and method for sorting returnable garment hangers have been disclosed. It should be apparent, however, to those skilled in the art that many more modifications besides those described are possible without departing from the inventive concepts herein. The inventive subject matter, therefore, is not to be restricted except in the spirit of the appended.

1. An automation system and method for sorting returnable hangers comprising:
a) an entering area (Aing) where hangers enter and are physical separated with stops (101) on a first conveyor belt (10) wherein said first conveyor belt has an upward slope, said hangers then are sequenced on a second conveyor belt (20), wherein said second conveyor belt moves faster than said first conveyor belt (10);
b) at least one sensor element (S1) detects the presence of a hangers (200) on said second conveyor and records a hanger image (Areg) of each hanger (200) to capture a digital image (Dcap), said digital image (Dcap) of said hanger (200) and detects determines a surface, contour and a surface gloss level, said digital image (Dcap) is sent to a processing plant where said digital image (Dcap) is analyzed for a hangers (200) categorization according to attributes of previously registered hanger (200) images;
c) a hanger screening area (Atr) where said hangers (200) are categorized by the digital image (Dcap) and said hangers (200) are removed from the conveyor belt by at least one robot (30) designated by the processing plant and moved to a packaging area (Aac);
d) said packaging area (Aac) includes a rod (40) where a hook on said hanger (200) is fitted by the robot (30), said rod (40) is equipped with a sensor (S3) that allows for a counting of hanger (200) on said rod (40).

2. The automation system and method for sorting returnable garment hangers according to claim 1, characterized by comprising the steps:
a) hangers (200) that are returned for disposition on the first conveyor belt surface (10) of the entering area (Aing) of the flow of hangers (200) and physical separation of hanger (200) in the entering area (Aing) are provided with stops (101) for the physical separation of hangers (200);
b) hanger (200) displacement to said second conveyor belt (20) is with greater speed than the first conveyor belt (10) to increase physical distance between the hangers (200);
c) said hanger (200) presence is detected on the surface of the conveyor belt by the sensor element (S1) that trigger the digital image capture device (Dcap) in the coat hanger image recording area (Areg);
d) said digital image (Dcap) device records the hanger image (200) and the gloss intensity of the coat hanger surface (200) as the hanger (200) that moves on the surface of the conveyor belt and sends data on the surface, contour and gloss intensity of the hanger (200) to the processing plant;
e) said processing plant analyzes the image acquired by the digital image (Dcap) device and extracts attributes that provide a numerical data that allows for categorizing the hanger in accordance with the models previously registered in the processing plant, by detecting the hanger (200) contour and the gloss level;
f) if the hanger (200) contour is equivalent to the pattern stored in the processing unit's memory, the hanger is categorized;
g) if the hanger's (200) contour or surface differs from the pattern stored in the processing plant's memory, the hanger is classified as a disposal item;
h) if the gloss level of the hanger (200) is less than the value registered in the processing plant database, the hanger (200) is classified as a disposal item;
i) the categorized hangers (200) are moved to the screening coat hanger's area (Atr) where at least one parallel robot (30) is installed which removes the designated hanger (200) from the surface of the conveyor belt and moves the hanger (200) to a packing area (Aac);
j) a packaging area (Aac) that is equipped with a device that includes a rod (40) for fitting the hanger hook (200) by the robot (30), said rod is equipped with a sensor (S3) for counting the hangers (200) on the rod;
k) hangers (200) that are not categorized by the processing plant are returned to the entering Area (Aing) through a return conveyor (Eret).

3. The automation system and method for sorting returnable garment hangers according to claim 2, are characterized based upon an image pre-processing step and/or an image segmentation provided by the digital image (Dcap) capture device.

4. The automation system and method for sorting returnable garment hangers according to claim 2, are characterized by the robot (30) by screening several categories of hangers that are assigned to a device in the packaging area (Aac).

5. The automation system and method for sorting returnable garment hangers according to claim 2, are characterized by hanger (200) that are not selected by the robot (30) are returns to the entering area (Aing) and are placed in a container (50) for disposed at the exit of the hanger screening area (Atr).
